(19) United States
(12) Patent Application Publication
(10) Pub. No.: US 2017/0037289 A1
(43) Pub. Date: Feb. 9, 2017

(54) ABRASIVE GRAIN ON THE BASIS OF ELECTROFUSED ALUMINUM OXIDE WITH A SURFACE COATING COMPRISING TITANIUM OXIDE AND/OR CARBON

(71) Applicant: Center for Abrasives and Refractories Research and Development - C.A.R.R.D. GmbH, Villach St. Magdalen (AT)

(72) Inventor: Thomas FUCHS, Murg (DE)

(73) Assignee: Center for Abrasives and Refractories Research and Development- C.A.R.R.D. GmbH, Villach St. Magdalen (AT)

(21) Appl. No.: 15/304,787

(22) PCT Filed: Apr. 10, 2015
(86) PCT No.: PCT/EP2015/057908

§ 371 Date: Oct. 17, 2016

(30) Foreign Application Priority Data
Apr. 17, 2014 (DE) 102014105600.0
Mar. 17, 2015 (DE) 102015103934.6

(51) Int. Cl. C09K 3/14; C09C 1/40

(52) U.S. Cl. CPC C09K 3/1445; C09K 3/1436; C09C 1/407; C01P 2004/84; C01P 2004/64; C01P 2004/62; C01P 2004/61

(57) ABSTRACT

The present invention relates to an abrasive grain on the basis of electrofused aluminum oxide with a surface coating comprising titanium oxide and/or carbon, wherein compounds formed of titanium oxide and/or carbon particles at the abrasive grain surface by means of a temperature treatment are tightly connected to the abrasive grain surface without an additional binding agent.

The present invention relates to an abrasive grain on the basis of electrofused aluminum oxide with a surface coating comprising titanium oxide and/or carbon.

Abrasive grains are used in loose or bonded form, in particular for machining surfaces. When bonded, abrasive grains are used in the form of abrasive belts, abrasive papers, abrasive wheels or other bonded abrasives, wherein the efficiency of the machining of the surface does not only depend on the characteristics of the abrasive grain itself, but to a considerable extent also on the type and stability of the integration of the abrasive grains in the respective abrasives. The bounding surface between the abrasive grain and the binder phase is of particular importance thereby. Said bounding surface determines the force which is required to break an abrasive grain out of a bond. The harder and more stable an abrasive grain, the larger are the demands on the bond and on the adhesive forces at the bounding surfaces, because the easier it will be to break an abrasive grain out of the bond due to grinding.

Most of the abrasive grains, in particular those produced by means of a melting process, have a relatively smooth surface, which has disadvantageous effects for their integration in the abrasives, which is largely based on adhesion. To solve this problem, a plurality of methods for roughening or for enlarging the surface, respectively, and thus for improving the integration has thus already been proposed in the past.

U.S. Pat. No. 2,527,044 A describes a fused aluminum oxide abrasive grain provided with a coating of fine-particulate metal oxide particles, for example iron oxide, so as to improve the embedding in resin-bonded abrasives. The metal oxide particles adhere to the surface of the abrasive grain by means of a glass-like binder.

U.S. Pat. No. 2,541,658 describes the coating of abrasive grains with a phosphate binder and iron oxide pigments.

EP 0 014 236 A1 describes the treatment of a titanium oxide-containing abrasive grain on the basis of aluminum oxide, wherein a layer of a ceramic mass is fused onto the abrasive grain. Thereby, at the same time an oxidation of the titanium oxide, which is contained in the abrasive grain, takes place associated with a transformation of the structure of the abrasive grain.

In response to the coating with an abrasion-active fine grain according to EP 0 080 604 B1, fine grain particles are applied to the abrasive grain surface together with abrasion-active substances by means of a glass frit.

Abrasive grains comprising a coating of an aqueous binding agent and a complex fine-particulate oxide compound with the general composition AₓB_{y}O_{z} are described in DE 102 57 554 B4.

A disadvantage of the above-described methods, in the case of which the enlargement of the abrasive grain surface takes place by applying fine particles adhering to the grain surface by means of a binder, is that the stability of the bond decreases during the grinding operation due to a high stress and strong heating and that the abrasive grain breaks out of the abrasive bond.

EP 0 346 832 discloses a coated silicon carbide abrasive grain coated with a highly dispersive hydrophilic metal oxide without additional binding agents. The highly dispersive hydrophilic metal oxide is thereby preferably mixed in the dry state with the abrasive grains and does subsequently adhere to the surface thereof. Even though the binder was abandoned in this case, however, due to the fact that the particles adhere to the surface only due to physical adhesion, it can also be observed herein that the stability of the bond in the abrasives decreases during the grinding operation and the abrasive grain breaks out of the bond.

EP 0 652 918 describes an abrasive grain comprising a metal oxide coating, wherein precursors of alpha-aluminum oxide abrasive grains are coated with a coating composition comprising a metal alkoxide, wherein the coated particles are subjected to a temperature treatment, so as to obtain a metal oxide coating which is autogenously bonded to the surface of the particles. Green bodies, which are obtained via a sol-gel method from a boehmite dispersion after drying and calcination and which are treated by means of a solution comprising a metal alkoxide, are used as base particles. The green bodies treated in this manner are subjected to a temperature treatment of between 400° C. and 1000° C., wherein a transformation of the metal alkoxide to metal oxide takes place, which metal oxide is autogeneously bonded to the surface of the base particles. The coated base particles are subsequently sintered at temperatures of between 1200° C. and 1650° C., so as to obtain an alpha-aluminum oxide abrasive grain. A disadvantage of this method is that it is very complicated and furthermore limited to abrasive grains which are obtained via sol-gel methods.

There is thus still the need for a coating having advantages as compared to the state of the art, in particular for abrasive grains produced via a melting process.

It is thus the object of the present invention to provide a coated abrasive grain on basis of electrofused aluminum oxide comprising an enlarged surface, which grain can be integrated well and permanently in the abrasives even in response to a strong mechanical and thermal stress and which thus does not have the described disadvantages of the state of the art.

The object is solved by means of an abrasive grain on the basis of electrofused aluminum oxide with a surface coating comprising titanium oxide and/or carbon, wherein compounds of titanium oxide and/or carbon particles formed at the abrasive grain surface by means of a temperature treatment are tightly connected to the abrasive grain surface. A direct tight bond without an additional binding agent is thereby formed by reactive sintering between the abrasive grain surface and the titanium oxide and/or carbon compounds comprising an average particle size of between 10 nm and 10 μm.

When searching for a possibility for improving the surface structure of abrasive grains on the basis of electrofused aluminum oxide, it was found that abrasive grains are obtained, in the case of which a direct tight bond is formed between the abrasive grain surface and the titanium oxide compounds comprising an average particle size of between 10 nm and 10 μm without an additional binding agent in response to a coating with a fine-particulate reactive titanium oxide and a subsequent temperature treatment.

A particularly well-suited base material for the coating is a pyrogenic titanium oxide which is offered by Evonik under the name Aeroxide TiO₂ P25 and the average primary particle size of which is 21 nm. Further tests then showed that also considerably coarser TiO₂ particles can be successfully used under correspondingly adapted reaction conditions, wherein the average size of the primary particles is preferably between 10 nm and 1 μm, more preferably between 10 nm and 100 nm.

With optical analyses of the coated abrasive grains, it was found that the distribution of the particles bonded on the surface is relatively inhomogeneous and that concentrations of titanium oxide compounds can be found in particular at the edges, recesses and fissures. It also became evident thereby that the particle size of the titanium oxide compounds formed on the surface of the abrasive grain is relatively coarse and inhomogeneous, which is most likely due to the fact that an irregular crystal growth takes place during the temperature treatment.

Due to these concentrations of the coating particles at the grain edges and flaws on the abrasive grain surface, stability analyses were also carried out using individual coated grains, whereby it turned out that the abrasive grains coated and sintered with titanium oxide have an increased grain toughness as compared to the uncoated abrasive grains.

The grain toughness of the abrasive grains was determined via the micro grain decomposition by grinding in a ball mill, wherein 10 g of corundum (of corresponding grit size) are ground in a ball mill filled with 12 steel balls (diameter 15 mm, weight 330-332 g) at 188 revolutions per minute for a predetermined period of time. The ground abrasive grain is subsequently screened in a screening machine (Haver Böcker EML 200) for 5 minutes via a corresponding fine screen, which is 2 classes finer than the bottom screen, which is defined for the corresponding grit size, and the fine fraction is weighed out. The MKZ value follows from:

$$MKZ ( \% ) = \frac{screen passage fine screen}{total weight} \times 100$$

In the context of the tests, mixtures of titanium oxide with carbon were then also used, so as to possibly further improve the physical characteristics of the individual grains by simultaneously forming reduced titanium oxide compounds. Surprisingly, it was found thereby that coated abrasive grains, which, on the one hand, encompass excelling stability values and which, on the other hand, reveal good grinding efficiencies, are not only obtained when partially, but also when completely replacing titanium oxide with carbon.

Sintering tests were carried out using differently coated and uncoated abrasives grains at temperatures between 800° C. and 1400° C., whereby it became evident that the grain toughness generally increases with increasing sintering temperature. Furthermore, it was found that the grain toughness of all grains on basis of electrofused aluminum oxide coated with titanium oxide and/or carbon disproportionally increases in comparison to the uncoated grains in response to a characteristic temperature with regard to the respective coating. This characteristic temperature exceeds in all cases 800° C., mostly 1000° C. and 1250° C., respectively, so that the titanium oxide and/or carbon particles are sintered at a temperature of more than 800° C., preferably more than 1000° C., and more preferably more than 1250° C.

The percentage by weight of the surface coating is advantageously between 0.01 and 5% by weight, based on the weight of the untreated grain, whereby a preferred embodiment of the present invention comprises 1 to 2% by weight surface coating. Thereby, the layer thickness of the surface coating is preferably less than 10 μm.

It was also found that the ratio of TiO₂ to carbon should be advantageously in the range from 10:1 to 1:10 prior to the sintering when using mixtures of titanium oxide and carbon.

Some selected coatings for abrasive grains on basis of electrofused aluminum oxide are characterized in Table 1 below via the micro grain decomposition.

Mono-crystalline aluminum oxide by Imerys Fused Minerals with the name SCT SK in the grit size F46 according to FEPA was used for the tests. Highly dispersive titanium oxide comprising an average particle size of between 10 nm and 50 nm as well as carbon black, also comprising an average particle size of between 10 nm and 50 nm, were used as base materials for the coating, wherein Aeroxide TiO₂ P25 by Evonik and Carbon Black Raven PFEB by IMCD Deutschland GmbH & Co. KG having an average particle size of 21 nm and 24 nm, respectively, were used in the context of the analyses. The sintering was carried out at 1200° C. and 1350° C., respectively, in the present of air.

TABLE 1
Abrasive Grain: Mono-crystalline aluminum oxide SCTSK
Grit Size: F46 (FEPA)

| | |
|---|---|
| Coating | |
| (wt. %) | MKZ (%) |

| Example | TiO₂ | C | 1200° C. | 1350° C. |
|---|---|---|---|---|
| 1 (Comparison) | — | — | 6.0 | 5.7 |
| 2 | 0.5 | — | 5.7 | 5.3 |
| 3 | 1.0 | — | 4.8 | 4.3 |
| 4 | 2.0 | — | 4.2 | 3.8 |
| 5 | — | 0.5 | 5.5 | 5.1 |
| 6 | — | 1.0 | 4.9 | 4.2 |
| 7 | — | 2.0 | 4.9 | 4.4 |
| 8 | 0.75 | 0.25 | 4.8 | 4.3 |
| 9 | 0.50 | 0.50 | 4.6 | 4.5 |
| 10 | 0.25 | 0.75 | 5.0 | 4.4 |

Due to the fact that the screen passage (=abrasion) is weighed out to determine the MKZ value, this means for the table above that the grain toughness is higher, the smaller the MKZ value.

### Grinding Tests

To also verify the positive effect of the MKZ values for the grinding practice, additional grinding tests were carried out in the case of examples 1 to 10 treated at 1350° C.

For this purpose, thin cut-off wheels were produced with the dimensions 125×1.2×22.23 mm, by means of which different workpieces were then cut, wherein 3 precuts were initially carried out for conditioning the wheel and a total of 24 cuts was subsequently carried out by means of each wheel. The grinding efficiency was determined via the decrease of the wheel diameter (wheel wear), wherein the so-called G-ratio was determined as dimension for the grinding efficiency via the wheel wear and the cutting area. The grinding results for the different workpieces and materials are summarized in Tables 2 to 4.

TABLE 2
Grinding machine: FEIN WS14
Power: 1.2 kW
Speed: 8.800 rpm
Number of cuts: 24
Workpiece: angle (30/30/3 mm)
Material: ST 37
Abrasive: cut-off wheel (125 × 1.2 × 22.23 mm)
Abrasive grain: SCTSK F46

| | | | Grinding |
|---|---|---|---|
| Example | Wear | G-ratio | efficiency |
| 1 (Comparison) | 6.4 mm | 3.53 | 100% |
| 2 | 4.6 mm | 4.87 | 138% |
| 3 | 4.8 mm | 4.66 | 132% |
| 4 | 4.3 mm | 5.19 | 147% |
| 5 | 6.2 mm | 3.62 | 103% |
| 6 | 5.6 mm | 3.99 | 113% |
| 7 | 5.3 mm | 4.26 | 121% |
| 8 | 4.2 mm | 5.35 | 152% |
| 9 | 4.6 mm | 4.91 | 139% |
| 10 | 5.5 mm | 4.05 | 122% |

In the case of the grinding test series summarized in Table 2 above, a construction steel ST37 angle with the dimensions 30×30×3 mm was cut a total of 24 times and the wear of the cut-off wheels was subsequently determined.

All cut-off wheels comprising coated abrasive grains show lower wear and thus a better grinding efficiency than the cut-off wheel comprising the uncoated reference grain (example 1). Even though the best result is reached with 2% by weight of TiO₂ (example 4) in the case of the abrasive grains, which are only coated with TiO₂, a clear trend that the grinding power also increases with an increasing coating portion cannot be derived in view of the results with 0.5% by weight of TiO₂ (example 2) and 1.0% by weight of TiO₂ (example 3). The cut-off wheels comprising abrasive grains only coated with carbon (examples 5-7) wear considerably more than the before-mentioned cut-off wheels. The result for the abrasive grains coated with 0.5% by weight of carbon is thus not much better than that for the uncoated reference grain. The result of the cut-off wheel, in the case of which a mixture of 0.25% by weight of carbon and 0.75% by weight of TiO₂ was used for the coating of the abrasive grain (example 8), is surprisingly good.

A test series, in the case of which a tube of stainless steel (V2A) comprising a thickness of 2 mm and a diameter of 20 mm was cut, is summarized in Table 3 below. As usual, the grinding efficiency was determined via the wheel wear. As a whole, all of the grinding results are considerably inferior to the case of the construction steel. As a whole, the results of the cut-off wheels comprising the abrasive grains only coated with carbon were the worst (examples 5-7). The cut-off wheel comprising the abrasive grains coated with the mixture of 0.25% by weight of carbon and 0.75% by weight of TiO₂ (example 8) again shows a very good result along with the wheels comprising the abrasive grains only coated with 1% by weight and 2% by weight of TiO₂.

TABLE 3
Grinding machine: FEIN WS14
Power: 1.2 kW
Speed: 8.800 rpm
Number of cuts: 24
Workpiece: tube (20/2 mm)
Material: V2A (1.4301)
Abrasive: cut-off wheel (125 × 1.2 × 22.23 mm)
Abrasive grain: SCTSK F46

| | | | Grinding |
|---|---|---|---|
| Example | Wear | G-Factor | efficiency |
| 1 (comparison) | 2.98 mm | 4.33 | 100% |
| 2 | 2.60 mm | 4.97 | 114% |
| 3 | 2.34 mm | 5.52 | 127% |
| 4 | 2.36 mm | 5.47 | 126% |
| 5 | 2.72 mm | 4.88 | 113% |
| 6 | 2.58 mm | 5.00 | 115% |
| 7 | 2.57 mm | 5.02 | 116% |
| 8 | 2.31 mm | 5.59 | 127% |
| 9 | 2.63 mm | 4.91 | 113% |
| 10 | 2.79 mm | 4.63 | 106% |

In the last test series summarized in Table 4 below a 20 mm rod of grey cast iron (GG25) was machined.

As a whole, higher power increases as compared to the cut-off wheel comprising an uncoated abrasive grain were reached again in the case of this material. The best results were obtained again with example 4 (2% TiO₂) and with example 8 (0.25% carbon, 0.75% TiO₂). In the case of this test series, the results of examples 2-4 appear to confirm an increase of the grinding efficiency as the TiO₂ content increases. However, this trend is not so pronounced that it is questionable, whether a do sling of the use of the expensive raw material pyrogenic TiO₂ will be economically justified in the case of practical application.

TABLE 4
Grinding machine: FEIN WS14
Power: 1.2 kW
Speed: 8.800 rpm
Number of cuts: 24
Workpiece: rod (20 mm)
Material: grey cast iron (GG25)
Grinding means: cut-off wheel (125 × 1.2 × 22.23 mm)
Abrasive grain: SCTSK F46

| | | | Grinding |
|---|---|---|---|
| Example | Wear | G-ratio | efficiency |
| 1 (comparison) | 0.42 mm | 97.08 | 100% |
| 2 | 0.37 mm | 109.21 | 112% |
| 3 | 0.32 mm | 127.42 | 131% |
| 4 | 0.29 mm | 140.60 | 145% |
| 5 | 0.39 mm | 104.55 | 108% |
| 6 | 0.31 mm | 131.53 | 135% |
| 7 | 0.36 mm | 113.26 | 116% |
| 8 | 0.28 mm | 145.62 | 150% |
| 9 | 0.35 mm | 116.50 | 120% |
| 10 | 0.39 mm | 104.55 | 108% |

The enclosed images taken with a scanning electron microscope provide a plausible explanation for the more or less highly-distinct power increase in response to the use of different coating particles.

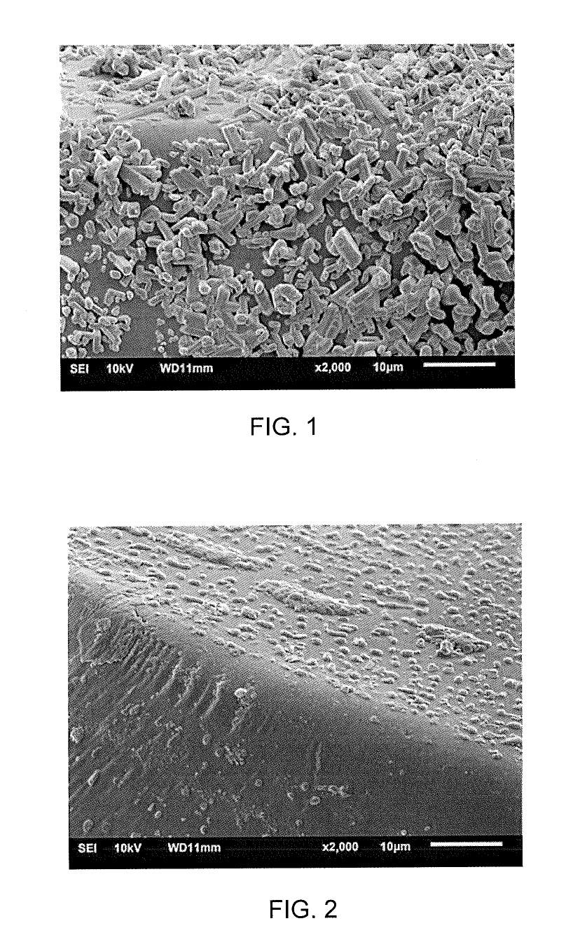

FIG. 1 thereby shows the surface of an abrasive grain coated with 2% by weight of TiO₂ in 2.000-fold magnification, on which relatively coarse, mostly elongated TiO₂ crystals or aluminum titanate crystals can be seen, wherein some particles reach a longitudinal expansion of more than 10 μm. In this connection, it has to be noted that the chemical and crystallographic composition of the compounds was not investigated in detail. As a whole, the average particle size, however, lies in the range of between 0.01 μm and 10 μm, preferably in the range of between 1 μm and 10 μm. Pyrogenic TiO₂ with an average particle size of between 10 and 50 nm was used as base material, so that also a strong irregular crystal growth had to have taken place during the temperature treatment. The surface itself is considerably increased due to the particles tightly connected thereto, whereby an excellent integration of the correspondingly coated abrasive grains into the binding agent matrix of the abrasives is to be expected, which is confirmed by means of the grinding tests. It can furthermore be seen in FIG. 1 that the coating of the surface with TiO₂ comprising particles is relatively dense providing an explanation for the fact that coated abrasive grains comprising less TiO₂ on the surface also show good grinding efficiencies.

FIG. 2 shows the surface of an abrasive grain coated with 1% by weight of carbon also in 2.000-fold magnification. In contrast to the TiO₂ crystals, the carbon comprising particles show an amorphous structure, wherein some clusters having a diameter of more than 10 μm are also present in this case. It could not be finally clarified to which extent the sinter-fused particles are carbides, oxy-carbides or other mixed crystals in the system Al, C, O, and N. The average particle size herein also lies within a range of between 0.01 and 10 μm. The amorphous rounded shape of the carbon comprising particles suggests that the integration of the correspondingly treated abrasive grains into the binding agent matrix will not be as tight as that of the abrasive grains with the TiO₂ containing particles on the surface, which form corners and edges, by means of which the abrasive grain is anchored in the binding agent matrix.

1. An abrasive grain on the basis of electrofused aluminum oxide with a surface coating comprising titanium oxide and/or carbon, wherein compounds formed of titanium oxide and/or carbon particles at the abrasive grain surface by a temperature treatment are tightly connected to the abrasive grain surface,
characterized in that
a direct tight bond without an additional binding agent is formed between the abrasive grain surface and the titanium oxide and/or carbon compounds comprising an average particle size of between 0.01 μm and 10 μm.

2. The abrasive grain according to claim 1,
characterized in that
the titanium oxide and/or carbon compounds tightly connected on the surface have an average particle size in the range of between 1 μm and 10 μm.

3. The abrasive grain according to claim 1,
characterized in that
the percentage by weight of the surface coating is between 0.01 and 5% by weight, based on the weight of the untreated abrasive grain.

4. The abrasive grain according to claim 1,
characterized in that
the surface coating has a layer thickness of less than 10 μm.

5. The abrasive grain according to claim 1,
characterized in that
the titanium oxide and/or carbon particles are sintered onto the abrasive grain surface at a temperature of more than 800° C.

6. The abrasive grain according to claim 1,
characterized in that
the ratio of TiO₂ to carbon is between 10:1 and 1:10 prior to the sintering when using mixtures of TiO₂ and Carbon.

7. A method for making an abrasive grain on basis of electrofused aluminum oxide with a surface coating comprising titanium oxide and/or carbon, wherein the titanium oxide and/or carbon compounds formed in response to the coating are tightly connected to the abrasive grain surface, wherein a mixture of abrasive grains and titanium oxide and/or carbon particles comprising an average particle size of between 10 nm and 10 μm is produced, wherein the titanium oxide and/or carbon particles are sintered onto the abrasive grain surfaces without additional binding agents at a temperature of more than 800° C.

8. The method according to claim 7,
characterized in that
highly dispersive titanium oxide comprising an average particle size of between 10 nm and 50 nm is used as titanium oxide particles.

9. The method according to claim 7,
characterized in that
carbon black comprising an average particle size of between 10 nm and 50 nm is used as carbon particles.

10. The abrasive grain according to claim 5, characterized in that the titanium oxide and/or carbon particles are sintered onto the abrasive grain surface at a temperature of more than 1000° C.

11. The abrasive grain according to claim 5, characterized in that the titanium oxide and/or carbon particles are sintered onto the abrasive grain surface at a temperature of more than 1250° C.
